(19) United States
(12) Patent Application Publication
(10) Pub. No.: US 2008/0203250 A1
(43) Pub. Date: Aug. 28, 2008

(54) Speaker Pedestal With Hidden Wiring Channel

(76) Inventor: Hendrik Blok, Escondido, CA (US)

Correspondence Address: STEVEN W. WEBB, 825 College Blvd., Suite 102620, Oceanside, CA, 92057, US

(21) Appl. No.: 11/677,815

(22) Filed: Feb. 22, 2007

(51) Int. Cl. F16M 11/00

(52) U.S. Cl. 248/158; 248/176.1

(57) ABSTRACT

An improved speaker pedestal stand is presented, which possesses features that permit the hiding form view of speaker wire and cable. These features make it easy to conceal the speaker wires from the back of the speaker through the speaker stand to the floor, where they can be attached to a music system. This invention decreases visual clutter in living spaces and increases safety by preventing children and pets from encountering the wires.

### FIELD OF THE INVENTION

The present invention is related to a speaker mounting systems and associated methods. More particularly, the present invention is related to a speaker pedestal mounting system and method with concealed channels suited to hiding the speaker wiring associated with connecting a music system.

### BACKGROUND OF THE INVENTION

Speaker mounting systems must provide a certain amount of aesthetic input to a living space, avoiding clutter and disguising some of the less attractive aspects of music system hardware. Speakers are often made of decorative woods and are patterned and configured to match furniture and wall decoration motifs.

Thus speaker mounting flexibility has become more important with the increased popularity of home theater systems that include speakers of varying types, sizes, and power rating.

Current speaker mounting systems need improved mounting flexibility. A typical speaker stand provides vertical adjustment but no opportunity to hide the necessary wiring. A need exists for a speaker mounting system which meets the needs of decorators to remove distracting electrical components and wiring from the living environment.

### BRIEF SUMMARY OF THE INVENTION

The present invention concerns a speaker mounting system and method comprised of an improved speaker mounting pedestal with channels and conduits for conducting speaker wiring from the back of the speaker to the floor. As such, the present invention allows a user to attach and to detach at least one audio speaker from the pedestal top. In addition, the present invention allows a user to position the speaker unit for adjusting the acoustic sound pattern in a given room.

A further feature of this invention is that the proposed pedestal design is both functional and minimally decorative, but can be configured to meet other decorative needs.

An optional aspect of the speaker pedestal system is that the wiring encased in the hidden conduits is less likely to pose a safety hazard, and can be kept away from pets and children.

In another embodiment, the speaker mounting system has a detachable base stand, including at least one base attaching feature, for ease of mounting the pedestal on another piece of furniture.

### BRIEF DESCRIPTION OF THE FIGURES

FIG. 1. Perspective view of the assembled invention

FIG. 2. Exploded view of the invention

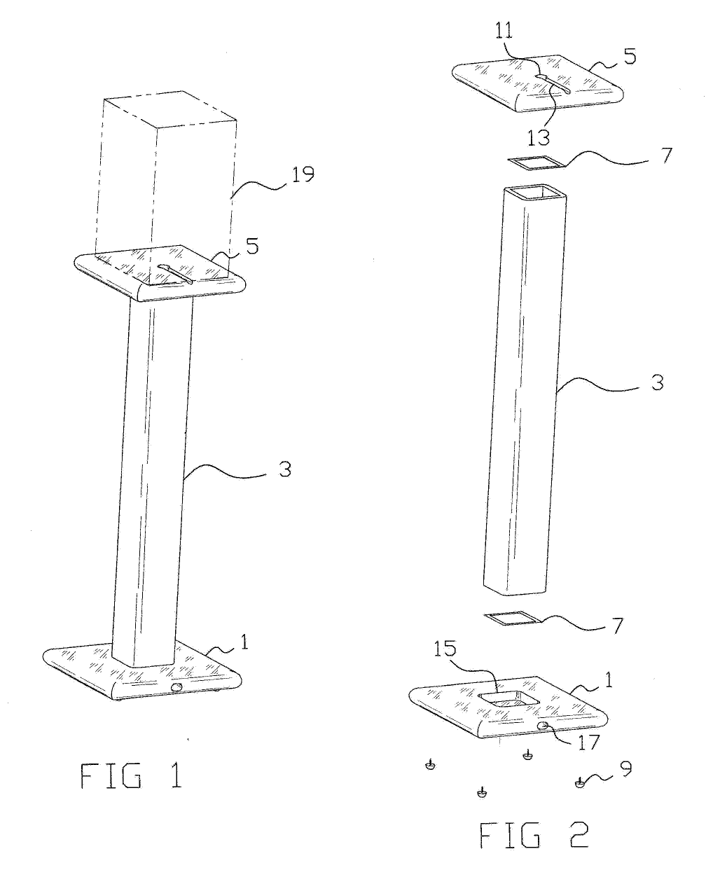

### DETAILED DESCRIPTION

The present invention is comprised of a pedestal base 1, a pedestal 3, a pedestal top 5, two grommet seals 7, a plurality of base stand feet 9, a pedestal top groove 13, a pedestal top hole 11, a pedestal receptacle 15, and a pedestal base hole 17. The invention is assembled in the preferred embodiment by removably attaching the pedestal 3 to the pedestal top 5 with one of the grommet seals 7 such that the pedestal top groove 13 and pedestal top hole 11 are exposed.

A speaker of an appropriate size is then wired and the wire is passed through the pedestal top hole, through the pedestal 3, and emerges at the open end of the pedestal 3. The wire is then inserted through the other grommet seal 7, then the pedestal receptacle 15, and finally emerges through the pedestal base hole 17.

The invention is then assembled by removably attaching the pedestal 3 to the pedestal base 1 at the pedestal receptacle 15, with the speaker wire passing from the top of the invention through to the bottom. The speaker is then positioned on top of the pedestal top 5 such that the speaker wire enters the pedestal top groove 13 at the end closest to the edge of the pedestal top 5, then continues through the pedestal top hole 11 down through the invention, emerging at the pedestal base hole. The slack in the wire is taken up, and the end of the wire can then be connected to the music system.

While the foregoing describes a preferred method, variation on this design and equivalent methods may be resorted to in the scope and spirit of the claimed invention.

What is claimed is

1. a pedestal speaker stand, the speaker stand comprised of a pedestal base, a pedestal, a pedestal top, and a plurality of grommet seals,
the pedestal top possessing a centrally-located pedestal top hole connected to a pedestal top groove, the pedestal top groove running centripetally from the pedestal top hole to the edge of the pedestal top,
the pedestal base possessing a centrally-located pedestal receptacle and a pedestal base hole, the pedestal receptacle a depression in the surface of the pedestal base, the pedestal base hole running centripetally from the interior edge of the pedestal receptacle through the material of the pedestal base until it emerges at the edge of the pedestal base,
the pedestal base also possessing a plurality of pedestal base feet.

2. A method of assembling said pedestal speaker stand with a music speaker system, the method comprising the steps of
removably attaching the pedestal to the pedestal top with one of the grommet seals such that the pedestal top groove and pedestal top hole are exposed,
obtaining a music speaker of an appropriate size, wiring the speaker, and then passing the wire through the pedestal top hole, through the pedestal, and and then through the open end of the pedestal,
inserting the wire through another grommet seal, then
inserting the wire through the pedestal receptacle, through the opening of the pedestal base hole in the pedestal receptacle, and then passing it through the pedestal base hole to the other end of the pedestal base hole,
removably attaching the pedestal to the pedestal base at the pedestal receptacle with the second grommet in between the open end of the pedestal and the pedestal receptacle, with the speaker wire passing from the top of the invention through to the bottom,
then positioning the speaker on top of the pedestal top such that the speaker wire enters the pedestal top groove at the end closest to the edge of the pedestal top, then continues through the pedestal top hole down through the pedestal, emerging at the pedestal base hole.
